(19) United States
(12) Patent Application Publication
(10) Pub. No.: US 2014/0331966 A1
(43) Pub. Date: Nov. 13, 2014

(54) METHOD FOR OPERATING A GASOLINE ENGINE HAVING A COMPLETELY OPEN THROTTLE VALVE AND A GASOLINE ENGINE

(71) Applicants: Matthias WETTIG, Talheim (DE); Markus HERBORD, Heilbronn (DE); Simon WEISSENMAYER, Marbach (DE)

(72) Inventors: Matthias WETTIG, Talheim (DE); Markus HERBORD, Heilbronn (DE); Simon WEISSENMAYER, Marbach (DE)

(73) Assignee: Robert Bosch GmbH, Stuttgart (DE)

(21) Appl. No.: 14/275,285

(22) Filed: May 12, 2014

(30) Foreign Application Priority Data
May 13, 2013 (DE) 10 2013 208 697.0

(51) Int. Cl. F02D 17/02; F02D 41/22; F02D 41/00

(52) U.S. Cl. CPC F02D 17/02; F02D 41/0002; F02D 41/221; F02D 2041/227
USPC 123/333

(57) ABSTRACT

A method is described for operating a gasoline engine having at least one throttle valve controlling a combustion air supply for at least two cylinders, the at least one throttle valve being opened completely and a power output of the gasoline engine being controlled by deactivating at least one of the at least two cylinders.

### FIELD OF THE INVENTION

The present invention relates to a method for operating a gasoline engine having at least one throttle valve controlling a combustion air supply for at least two cylinders as well as a gasoline engine.

### BACKGROUND INFORMATION

In the case of gasoline engines, it may be provided to reset the throttle valve to a basic position for emergency operation in the event of an electrical or mechanical malfunction. Such a basic position may conform to a lower power requirement, which is normally adequate for moving a vehicle driven by the gasoline engine. This type of emergency operation is unsuitable, in particular for high availability applications such as those encountered, for example, in watercraft and aircraft. For example, marine and flight applications exist in which engine power above a certain threshold of the rated power must be ensured.

It is therefore desirable to provide a possibility for emergency operation which is also suitable for high availability applications.

### SUMMARY

According to the present invention, a method for operating a gasoline engine having at least one throttle valve controlling a combustion air supply for at least two cylinders as well as a gasoline engine are provided.

The present invention is based on the measure of completely opening a throttle valve controlling the combustion air supply for at least two cylinders, in particular in the event of a malfunction of this throttle valve, and influencing a power output of the gasoline engine by deactivating at least one of the at least two cylinders. This provides the possibility of influencing the power output of a gasoline engine within certain limits, even in the event of a completely open throttle valve, the number of power stages resulting from the number of cylinders.

Only a complete opening of the throttle in the event of an error would not solve the problem, since the operation then occurring at continuous full power would not be manageable. The result of this is a complete loss of power control (LOPC).

A complete opening of the throttle valve supplies the maximum possible quantity of air to the at least two cylinders, for which reason they are basically only able to deliver the maximum possible power or no power. In most operating modes, the quantity of gasoline must namely be adapted to the instantaneous quantity of air in order to achieve combustion. As a function of the power request by a vehicle driver (e.g., driver or pilot), it is then possible to fire only individual cylinders and thus adapt the power output gradually.

The throttle valve is preferably a normally open or currentlessly open throttle valve. A complete opening of the throttle valve in the event of a malfunction, for example, in the case of a defective actuator or a signal error, may, for example, be caused by a spring which pulls the throttle valve in the “open” direction and against which the actuator acts. Such throttle valves are in fact known for diesel engines; however, they are not used for gasoline engines.

Preferably, the at least one cylinder is deactivated on an alternating basis. This may protect the mechanics of the gasoline engine, since cylinders are fired on an alternating basis (e.g., known strategy of half-engine operation).

If the gasoline engine has more than one throttle valve, for example, in the case of multiple cylinder banks, one of the multiple throttle valves may be opened completely, at least one of the cylinders supplied with combustion air by the completely open throttle valve being deactivated or not fired. Another of the multiple throttle valves is operated in the conventional manner, in order to thus adapt the power output of the gasoline engine to the power request by the vehicle driver. This operating mode may be assumed in the event of a malfunction of a throttle valve; however, it may nonetheless also be assumed in the event of functioning throttle valves, for operating one in a completely open state and thus avoiding throttle losses. This has a positive impact on fuel consumption and on the associated environmental pollution. This approach might also be used for downsizing; an appropriate mechanical design of the engine would make it possible to deactivate individual cylinders.

In the event of a faulty throttle valve, the bank having the open throttle valve is used for the basic power; the bank having the functioning throttle valve is used for the fine tuning. In order to avoid throttle losses in the event of functioning throttle valves, one of the throttle valves is deliberately opened further or is opened completely, and individual cylinders are deactivated simultaneously.

For deactivating cylinders, the fuel supply may be interrupted to the cylinder or cylinders to be deactivated, for example, an entire engine bank. For reactivating the cylinder or cylinders or the entire engine bank, the fuel supply is resumed. Here, the so-called engine bank injection cutoff (MBEA) may be used in which only the injection into the cylinder or cylinders to be deactivated is interrupted (cut off); the valve-train assembly itself is not switched off.

The present invention is in particular suitable for applications, such as aircraft engines, in which a minimum power and a change of power must be possible simultaneously. For example, in the event of a throttle valve malfunction in an eight-cylinder gasoline engine having only one throttle valve, the cylinders are fired in such a way that the power may be set in steps of 12.5%. This lies, for example, below a typical LOPC threshold of 15%. This simplifies the software strategy for activating the individual cylinders.

An arithmetic unit according to the present invention, for example, a control unit of a gasoline engine, is, in particular, programmed for carrying out a method according to the present invention.

The implementation of the method in the form of software is also advantageous, since it entails very low costs, in particular when an executing control unit is also used for other tasks and is therefore present anyway. Suitable data media for providing the computer program are, in particular, diskettes, hard drives, flash memories, EEPROMs, CD-ROMs, DVDs, etc. A download of a program via computer networks (Internet, Intranet, etc.) is also possible.

Additional advantages and embodiments of the present invention arise from the description and the accompanying drawing.

It is understood that the features stated above and the features still to be explained below are usable not only in the particular combination specified but also in other combinations or alone without departing from the scope of the present invention.

The present invention is depicted schematically in the drawing based on an exemplary embodiment and is described in greater detail below with reference to the drawing.

### BRIEF DESCRIPTION OF THE DRAWING

FIG. 1 schematically shows a gasoline engine according to the present invention having two cylinder banks, each having a throttle valve, which may be operated according to a preferred specific embodiment of the present invention.

### DETAILED DESCRIPTION

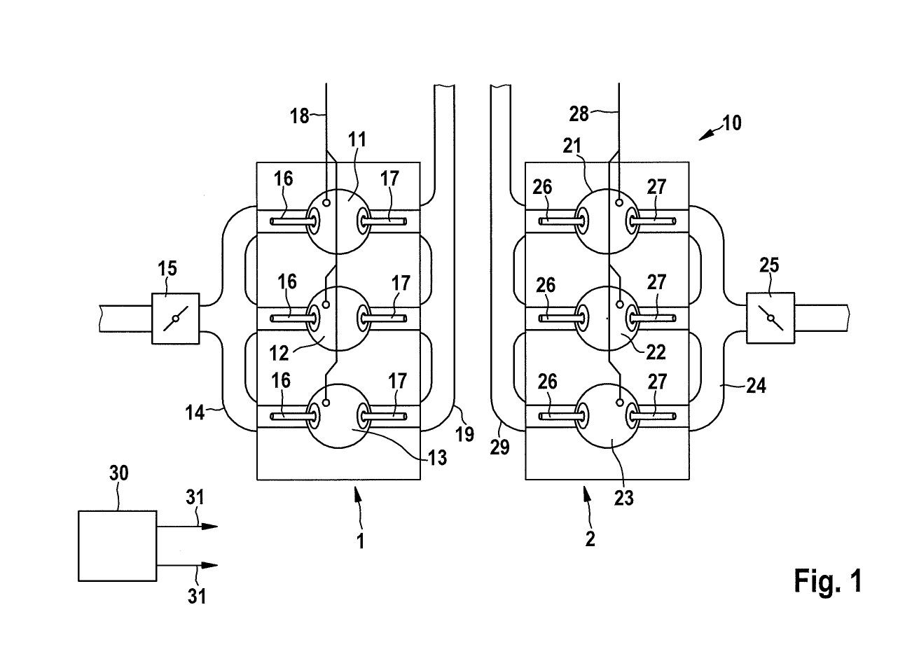

FIG. 1 shows a gasoline engine designed, for example, as an aircraft engine in a highly schematic partial representation and is generally denoted by reference numeral 10. Aircraft engine 10 may be operated with the aid of a method according to the present invention.

Aircraft engine 10 has two cylinder or engine banks 1, 2. Cylinders 11 through 13 (engine bank 1) and 21 through 23 (engine bank 2) are provided in each of engine banks 1, 2. An intake manifold system 14 and 24, which is equipped for supplying fresh air (combustion air) is assigned to each cylinder bank 1, 2. A throttle valve 15 is provided in intake manifold system 14; a throttle valve 25 is provided in intake manifold system 24. With the aid of throttle valves 15 and 25 it is possible to throttle the fresh air stream used to supply engine banks 1, 2. With the aid of intake valves 16 and 27, fresh air may be admitted into cylinders 11 through 13 (engine bank 1) and cylinders 21 through 23 (engine bank 2); via exhaust valves 17 and 26, a combusted air-fuel mixture or uncombusted fresh air (in the case of deactivated cylinders) may be expelled from cylinders 11 through 13 (engine bank 1) and cylinders 21 through 23 (engine bank 2) into corresponding exhaust manifolds 19 and 29).

Using injectors, fuel may be supplied to cylinders 11 through 13 (engine bank 1) and cylinders 21 through 23 (engine bank 2) via fuel lines 18 and 28 assigned to each of engine banks 1 through 2. As explained, the method includes single cylinder injection cut off during partial engine operation, so that due to the injection interruption, i.e., interruption of the fuel supply to certain cylinders, a fuel input into these cylinders is suppressed.

A control unit 30 is provided, which is able to influence a position of throttle valves 15 and 25 via signal lines (not shown) with the aid of control signals 31. Control unit 30 is programmed for operating aircraft engine 10 according to the present invention.

Aircraft engine 10 may be operated in an operating mode in which one of the throttle valves, for example, throttle valve 15, is completely open. This operating mode may be assumed in particular when throttle valve 15 is defective and it is no longer possible to regulate the position of the throttle valve. However, this operating mode may be assumed alternatively in order to avoid throttle losses. For the complete opening of throttle valve 15, a spring is provided which pretensions throttle valve 15 into the open position.

If throttle valve 15 is completely open, it is possible to influence the power output generated by engine bank 1 by deactivating one or multiple of cylinders 11, 12, 13. In this way, it is possible to set the power output of engine bank 1 in steps of (1/6)*100% of the total power output. In the event of a completely open throttle valve 15, it is thus possible to set the power output of engine bank 1 gradually from (0/6)*100% through (3/6)*100% of the total power output.

With the aid of a conventional, regulated operation of throttle valve 25, it is thus possible to set the power output of engine bank 2 continuously from (0/6)*100% through (3/6)*100% of the total power output.

What is claimed is:

1. A method for operating a gasoline engine having at least one throttle valve controlling a combustion air supply for at least two cylinders, comprising:
completely opening the at least one throttle valve; and
controlling a power output of the gasoline engine by deactivating at least one of the at least two cylinders.

2. The method as recited in claim 1, wherein the at least one throttle valve is opened completely one of in the event of a malfunction of the at least one throttle valve and in a targeted manner.

3. The method as recited in claim 1, wherein:
the gasoline engine includes at least one first throttle valve controlling a combustion air supply for at least one first cylinder and at least one second throttle valve controlling a combustion air supply for at least one second cylinder, and
the at least one first throttle valve is opened completely, and
a position of the at least one second throttle valve is variably controlled.

4. The method as recited in claim 1, further comprising controlling the power output of the gasoline engine as a function of a power request.

5. The method as recited in claim 1, further comprising deactivating at least one of the at least two cylinders in an alternating manner.

6. The method as recited in claim 1, further comprising deactivating at least one of the at least two cylinders with an aid of an injection cutoff.

7. An arithmetic unit for carrying out a method for operating a gasoline engine having at least one throttle valve controlling a combustion air supply for at least two cylinders, the method comprising:
completely opening the at least one throttle valve; and
controlling a power output of the gasoline engine by deactivating at least one of the at least two cylinders.

8. A computer program having a program code which induces an arithmetic unit to carry out a method when executed on the arithmetic unit, the method being for operating a gasoline engine having at least one throttle valve controlling a combustion air supply for at least two cylinders, the method comprising:
completely opening the at least one throttle valve; and
controlling a power output of the gasoline engine by deactivating at least one of the at least two cylinders.

9. A machine-readable storage medium having a computer program stored thereon, the computer program having a program code which induces an arithmetic unit to carry out a method when executed on the arithmetic unit, the method being for operating a gasoline engine having at least one throttle valve controlling a combustion air supply for at least two cylinders, the method comprising:
completely opening the at least one throttle valve; and
controlling a power output of the gasoline engine by deactivating at least one of the at least two cylinders.

10. A gasoline engine, comprising:
at least two cylinders; and
at least one throttle valve for controlling a combustion air supply for the at least two cylinders, the gasoline engine being configured in such a way that the at least one throttle valve is open in the event of a malfunction of the at least one throttle valve.

11. The gasoline engine as recited in claim 10, wherein the at least one throttle valve includes a currentlessly opened throttle valve.

12. The gasoline engine as recited in claim 10, further comprising an arithmetic unit for carrying out a method for operating a gasoline engine having at least one throttle valve controlling a combustion air supply for at least two cylinders, the method comprising:
completely opening the at least one throttle valve; and
controlling a power output of the gasoline engine by deactivating at least one of the at least two cylinders.

13. One of a ground vehicle, a watercraft, and an aircraft, comprising:
a gasoline engine, comprising:
at least two cylinders; and
at least one throttle valve for controlling a combustion air supply for the at least two cylinders, the gasoline engine being configured in such a way that the at least one throttle valve is open in the event of a malfunction of the at least one throttle valve.
